(19) United States
(12) Patent Application Publication
(10) Pub. No.: US 2007/0116937 A1
(43) Pub. Date: May 24, 2007

(54) Security element for documents in general and particularly for banknotes, security cards and the like

(76) Inventor: Maurizio Lazzerini, Cerro Al Lambro (IT)

Correspondence Address: Modiano & Associati, Via Meravigli 16, Milano, 20123, IT

(21) Appl. No.: 10/583,742

(22) PCT Filed: Oct. 29, 2004
(86) PCT No.: PCT/EP04/12316

§ 371 Date: Jun. 20, 2006

(30) Foreign Application Priority Data
May 17, 2004 (IT) MI2004A000984

(51) Int. Cl. B32B 3/00

(52) U.S. Cl. 428/209

(57) ABSTRACT

A security element for documents in general and particularly for banknotes, security cards and the like, comprising a flexible support layer that has a layer of metallic material on at least one face, said metallic layer having a substantially uniform thickness with a tolerance of less than +/−4%, and on said metallic layer at least regions are provided having a metal thickness that is less than 25% and more than 1% of the thickness of the layer of metallic material of the surrounding portions.

### TECHNICAL FIELD

The present invention relates to a security element for documents in general and particularly for banknotes, security cards and the like.

### BACKGROUND ART

WO 2004/014665, assumed included herein by reference, discloses a security element for documents in general and particularly for banknotes, security cards and the like, which has a support layer, generally made of polyester, on one face whereof there is a layer of metallic material, usually aluminum.

Regions are provided on the metallic layer which, by means of the removal of material, form characters or otherwise elements that are optically visible due to the fact that said regions have a different optical density.

In said Application, it is noted that the regions may have a thickness greater than 25% of the thickness of the surrounding regions.

Although this characteristic is extremely valid from a conceptual standpoint, it has been found to be susceptible of improvement in order to obtain regions of reduced thickness that are even more clearly visible for the user, accordingly allowing easy and unambiguous identification of said regions.

### DISCLOSURE OF THE INVENTION

The aim of the invention is to solve the problem described above by providing a security element for documents in general and particularly for banknotes, security cards and the like, in which the reduced-thickness regions may appear, for anyone viewing the security element in transmitted light, to be completely metal-free, thus fooling any counterfeiter who will be led to remove totally the metal thickness in said regions, consequently obtaining a product whose non-authenticity is particularly easy to verify.

Within this aim, an object of the invention is to provide a security element in which the use of particularly strict operational criteria leads to the possibility to obtain a product that has extremely reduced tolerances.

Another object of the present invention is to provide a security element that, by acting on the thicknesses of the reduced-thickness regions, allows to create an additional type of optical differentiation for said regions.

Another object of the present invention is to provide a security element that can be obtained simply and safely and is further competitive from a merely economical standpoint.

This aim and these and other objects that will become better apparent hereinafter are achieved by a security element for documents in general and particularly for banknotes, security cards and the like, which comprises a flexible support layer that has, on at least one face, a layer of metallic material, characterized in that said layer of metallic material has a substantially uniform thickness with a tolerance of less than +/−4%, and in that on said metallic layer at least regions are provided having a metal thickness that is less than 25% and more than 1% of the thickness of the layer of metallic material of the surrounding portions.

### BRIEF DESCRIPTION OF THE DRAWINGS

Further characteristics and advantages of the invention will become better apparent from the description of a preferred but not exclusive embodiment of a security element for documents in general and particularly for banknotes, security cards and the like, illustrated by way of non-limiting example in the accompanying drawings, wherein:

FIG. 1 is a schematic plan view of an embodiment of the security element according to the invention;

FIG. 2 is a sectional perspective view of the security element according to the invention;

FIG. 3 is a plan view of a portion of the security element, shaped like a ribbon or thread;

FIG. 4 is a highly enlarged-scale sectional view of the security element;

FIG. 5 is a sectional view of the security element after performing a first demetallization step;

FIG. 6 is a schematic view of the masking of the areas that have undergone a first demetallization step;

FIG. 7 is a schematic view of the security element after performing a second demetallization step.

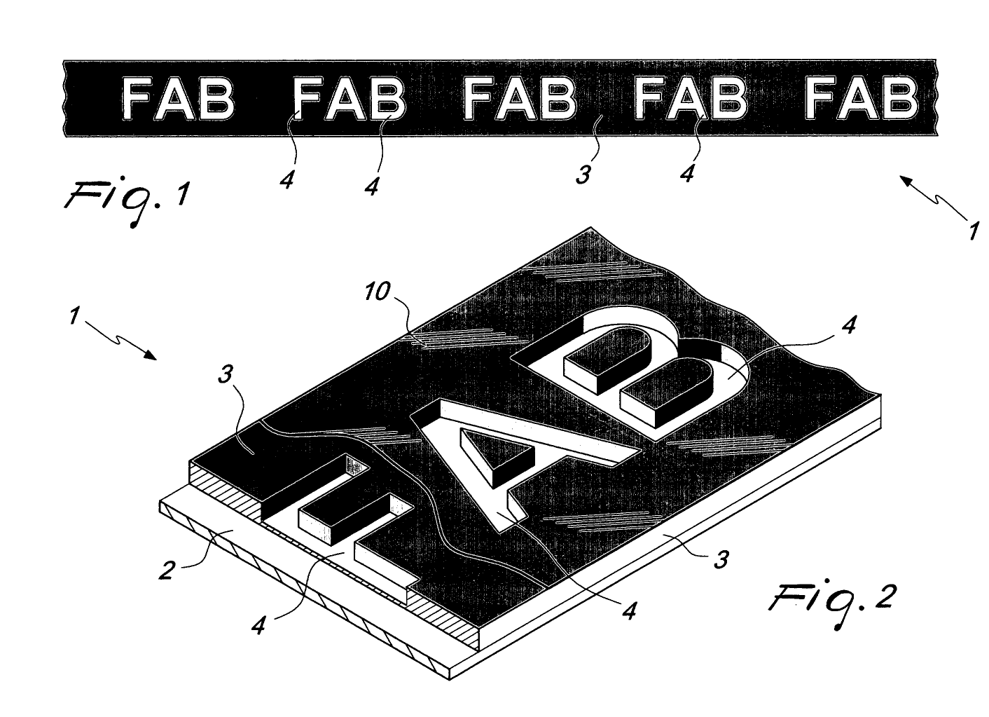

### WAYS OF CARRYING OUT THE INVENTION

With reference to the figures, the security element for documents in general and particularly for banknotes, security cards and the like according to the invention, generally designated by the reference numeral 1, comprises a flexible support layer 2, preferably made of polyester and the like.

The support layer may assume any shape deemed appropriate and may be obtained as a ribbon, thread or patch or in any case with any of the configurations typically used in the provision of security elements.

A layer of metallic material 3 that has the characteristic of having a highly uniform thickness, with a tolerance of up to +/−1%, is provided on the support layer 2 on one of its faces, but optionally also on both faces.

The uniformity of the thickness of the layer is an essential element in order to be able to obtain, as will become better apparent hereinafter, reduced-thickness regions that have particularly low thickness values.

To achieve a considerable uniformity in thickness it is possible, for example, to perform deposition by means of a metallizer that is capable of depositing the aluminum in vacuum by means of two or more series of crucibles installed in two contiguous vacuum chambers.

The two series of crucibles are arranged differently and offset by half the distance between them, and therefore it is possible to perform one metallization for each pass, depositing 1 optical density for each series of crucibles, thus obtaining a total layer of 2 optical density, with a tolerance of approximately 1%, so that values with a difference at the most of 0.02 optical density are achieved on the finished product.

A particularity of the invention further consists in that the thickness of the metal 3, in at least some regions 4, is reduced so as to assume a thickness that is less than 25% and more than 1% of the thickness of the metallic layer of the surrounding portions.

By using a layer thickness of 1.8 optical density, the reduced-thickness regions accordingly have a thickness comprised between 0.45 and 0.018 optical density.

With this solution, metallic continuity is maintained over the entire surface of the support layer, and the distinctive elements, which can be constituted by characters, indicia and the like, are immediately detectable by anyone viewing the thread in transmitted light.

The metallic layer may be obtained by means of aluminum metallized in vacuum or other metals such as chromium, lithium, copper or a combination of these metals.

Partial removal allows to maintain metallic continuity while having a different amount of metal between the regions where partial removal has occurred and the regions where removal has not occurred, allowing to obtain a visually verifiable element.

In a typical example of embodiment, the support layer is constituted by polyester, with a thickness comprised between 8 and 40 μm, which is metallized on one of its sides by means of a vacuum metallizer, depositing a layer of aluminum of 1.8 optical density.

To perform demetallization, a highly transparent ink, designated by the reference numeral 10 in the drawing and adapted to protect the aluminum against acid or basic substances, is printed onto the aluminum layer by means of normal printing operations; said inks are for example microcellulose inks with the addition of a catalyst or in any case of a hardening agent in a percentage equal to approximately 1%.

Once the masking layer has been applied, leaving free the regions where the layer is to be removed, in order to demetallize the polyester film on which it is printed, the metallic layer is passed through a tank that contains 52-54% phosphoric acid at a temperature of 46° C.+/−0.1° C. with a retention time of approximately 20-25 seconds.

To obtain an optimum product, it is important that the temperature of the acid can be controlled with an interval on the order of 0.1° C., and the titer of the acid must be controlled with centesimal precision, so as to be able to obtain demetallized areas that have a thickness that can reach 1% of the adjacent non-demetallized areas.

The film is then washed in a tank by using water, and at the exit from the tank the film is immersed in a tank with a buffer solution constituted by water and 3-5% ammonia.

The treated film is then abundantly rinsed, keeping the pH values constant in each tank.

At the exit from the last tank, the film is subjected to gentle wringing by means of rubber-coated rollers and is then passed through a hot air tunnel at a rate of 40 meters per minute and at a temperature of approximately 90-100° C.

The described method allows to obtain security threads on which the deposited aluminum has been removed partially, bringing it for example from 1.8 optical density to 0.07 optical density in the regions where the ink has not been printed.

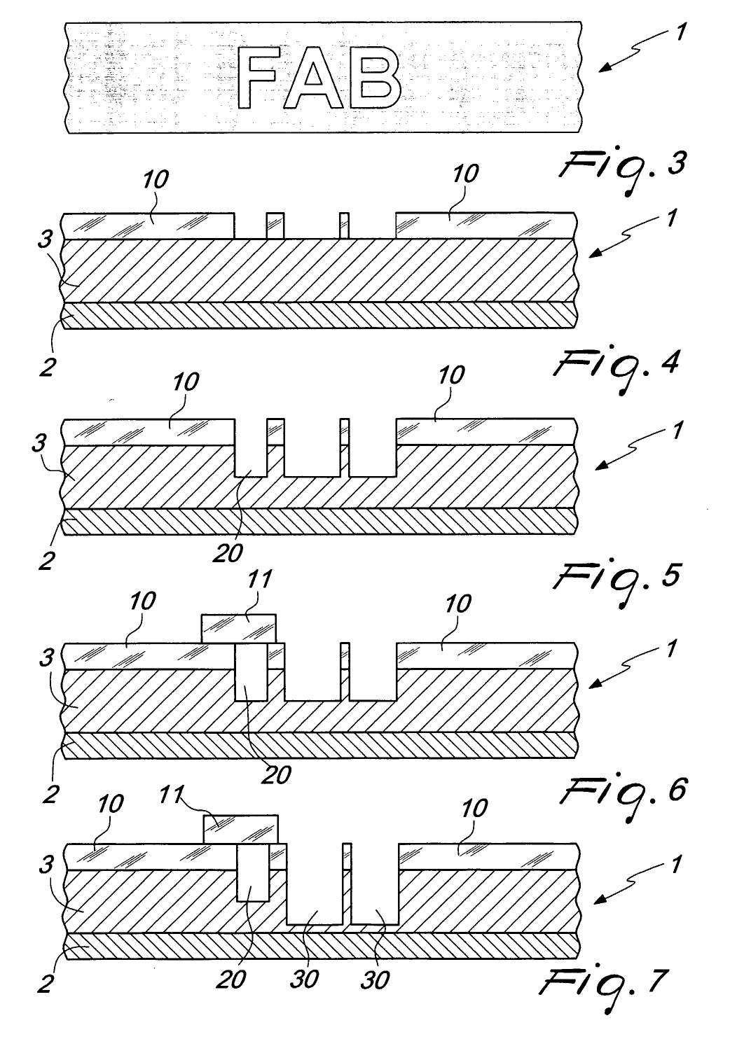

As shown in FIGS. 3 to 7, it is also possible to provide on the thread demetallized regions that have a different thickness.

Substantially, it is possible to obtain first regions, designated by the reference numeral 20, that have a first thickness reduction, and second regions 30 that have a second thickness reduction.

To provide this characteristic, after performing a first demetallization, obtained by applying a first protective layer 10 with free regions for acid etching, a second protective layer, designated by the reference numeral 11, is applied to some of the first demetallized regions 20 and an additional demetallization step is performed, producing the second regions 30, whose thickness is different both from the first regions and from the surrounding regions.

In this way it is possible to have elements or characters that are visible in transmitted light on the thread and have two different shades, thus providing an additional type of security element.

From what has been described above, it is thus evident that the invention achieves the intended aim and objects, and in particular the fact is stressed that by using a security element in which uniformity of deposition can be controlled with extremely high precision it is possible to provide regions in which the thickness of the metal is particularly low, thus providing. a metallic layer that is so thin that it can be practically likened to a space in which the metal is not provided, while however continuing to maintain the metallic continuity of the metal layer.

Moreover, the use of distinct regions having a reduced thickness with respect to the surrounding regions and with mutually different thicknesses allows to provide another security characteristic thanks to the fact that the regions, when viewed in transmitted light, appear to have mutually different shades.

It should be added to the above that it is possible to provide, on one or both faces of the support layer, fluorescent substances that have a solid or discontinuous background, holographic images with a solid or discontinuous background, continuous magnetic substances, which provide for example lateral bands or discontinuous substances that form codes; it is also possible to provide refractive or color-shifting substances.

The invention thus conceived is susceptible of numerous modifications and variations, all of which are within the scope of the appended claims.

Moreover, it should be added to the above that the ratio between the reduced-thickness surface and the full-thickness surface may be changed in any way, and therefore it is also optionally possible to provide the visually detectable characters by means of the full-thickness regions.

In the above examples of embodiments, individual characteristics, given in relation to specific examples, may actually be interchanged with other different characteristics that exist in other examples of embodiments.

Moreover, it is noted that anything found to be already known during the patenting process is understood not to be claimed and to be the subject of a disclaimer.

In practice, the materials used, as well as the contingent shapes and dimensions, may be any according to requirements.

The disclosures in Italian Patent Application no. MI2004A000984, from which this application claims priority, are incorporated herein by reference.

What is claimed is:

1-24. (canceled)

25. A security element for documents in general and particularly for banknotes, security cards and the like, comprising a flexible support layer that has, on at least one face, a layer of metallic material wherein said metallic layer has a substantially uniform thickness with a tolerance of less than +/−4%, and wherein on said metallic layer at least regions are provided having a metal thickness that is less than 25% and more than 1% of the thickness of the layer of metallic material of the surrounding portions.

26. The security element according to claim 25, wherein said regions can be detected visually.

27. The security element according to claim 25, wherein said metallic layer is made of aluminum.

28. The security element according to claim 25, wherein said metallic layer is made of chromium.

29. The security element according to claim 25, wherein said metallic layer is made of nickel.

30. The security element according to claim 25, wherein said metallic layer is made of copper.

31. The security element according to claim 25, wherein said metallic layer is made of a combination of aluminum, chromium, nickel and/or copper.

32. The security element according to claim 25, wherein said metallic layer has a thickness of less than 3 optical density.

33. The security element according to claim 25, further comprising fluorescent substances with a solid background on said support layer.

34. The security element according to claim 25, comprising discontinuous fluorescent substances on said support layer.

35. The security element according to claim 25, comprising holographic images with a solid background on said support layer.

36. The security element according to claim 25, comprising discontinuous holographic images on said support layer.

37. The security element according to claim 25, comprising continuous magnetic substances on said support layer.

38. The security element according to claim 25, comprising, on said support layer, discontinuous magnetic substances that provide a code.

39. The security element according to claim 25, comprising refractive substances on said support layer.

40. The security element according to claim 25, comprising color-changing substances on said support layer.

41. A security element for documents in general and particularly for banknotes, security cards and the like, comprising a flexible support layer that has a layer of metallic material on at least one face wherein said metallic layer has a uniform thickness with a tolerance of less than +/−4%, and wherein at least regions provided with a metal thickness that is comprised between 0.45 and 0.012 optical density are provided on said metallic layer.

42. The security element according to claim 41, wherein said regions can be detected visually.

43. The security element according to claim 41, further comprising fluorescent substances with a solid background on said support layer.

44. The security element according to claim 41, comprising holographic images with a solid background on said support layer.

45. The security element according to claim 41, comprising continuous magnetic substances on said support layer.

46. The security element according to claim 41, comprising refractive substances on said support layer.

47. The security element according to claim 41, comprising color-changing substances on said support layer.

48. A security element for documents in general and particularly for banknotes, security cards and the like, comprising a flexible support layer that has a layer of metallic material on at least one face, characterized in that it comprises, on said metallic layer, first regions and second regions that have a lower thickness than the layer of metallic material of the surrounding portions, said first and second regions having mutually different thicknesses.

49. The security element according to claim 48, wherein said regions can be detected visually.

50. The security element according to claim 48, further comprising fluorescent substances with a solid background on said support layer.

51. The security element according to claim 48, comprising holographic images with a solid background on said support layer.

52. The security element according to claim 48, comprising continuous magnetic substances on said support layer.

53. The security element according to claim 48, comprising refractive substances on said support layer.

54. The security element according to claim 48, comprising color-changing substances on said support layer.

55. A method for providing a metallic layer on a security element for documents in general and particularly for banknotes, security cards and the like, wherein it provides for the deposition of said metallic layer by means of two series of crucibles installed in two contiguous vacuum chambers, a thickness substantially equal to half of the total thickness being deposited for each pass for each series of crucibles.

56. A method for providing a security element for documents in general and particularly for banknotes, security cards and the like, consisting in metallizing at least one face of a support layer made of polyester; in applying, by printing, an ink for protecting said metallic layer; in demetallizing the ribbon in a tank that contains 52-54% phosphoric acid at a temperature of 46° C.+/−0.1° C., with a retention time of 20-25 seconds.

57. A method for providing a security element for documents in general and particularly for banknotes, security cards and the like, consisting in metallizing a support layer made of polyester, in providing on the resulting metallic layer a print by means of an ink for protecting said metallic layer except for the first regions; in providing a first demetallization by means of an acid; in applying to at least some of said first regions a protective layer by means of a protective ink; in performing a second demetallization in order to provide second regions that have a lower thickness of metal than said first regions.

58. A document in general, further comprising a security element according to claim 25, which is fully inserted therein.

59. A document in general, further comprising a security element according to claim 25, which is at least partially inserted therein.

60. A document in general, having a security element according to claim 25 on at least one of its outer faces.

61. A document in general, further comprising a security element according to claim 41, which is fully inserted therein.

62. A document in general, further comprising a security element according to claim 41, which is at least partially inserted therein.

63. A document in general, having a security element according to claim 41 on at least one of its outer faces.

64. A document in general, further comprising a security element according to claim 48, which is fully inserted therein.

65. A document in general, further comprising a security element according to claim 48, which is at least partially inserted therein.

66. A document in general, having a security element according to claim 48 on at least one of its outer faces.
